(19) United States
(12) Patent Application Publication
(10) Pub. No.: US 2003/0114120 A1
(43) Pub. Date: Jun. 19, 2003

(54) Antenna on a display

(76) Inventors: Wah Yiu Kwong, Beaverton, OR (US); Wayne L. Proefrock, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/023,018

(22) Filed: Dec. 17, 2001

(51) Int. Cl. H04B 1/38

(52) U.S. Cl. 455/90; 455/550; 455/575

(57) ABSTRACT

According to one embodiment, a handheld computing device is described. The handheld computing device includes a housing, a display mounted on the housing and an antenna located on the display.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to computer systems; more particularly, the present invention relates to an antenna embedded on a computer system display device.

### BACKGROUND

Recently, portable computing devices, such as personal digital assistants (PDAs), with wireless communication capabilities have become prevalent. Such computing devices typically include an antenna to transmit and receive data via radio frequency (RF). In most instances, the antenna protrudes externally from the device. However, in such instances where the antenna protrudes from the device, the antenna may be bent or broken. One solution is to locate the antenna inside the housing of the device. However, if the housing includes a metal component, the metal component of the housing may interfere with the antenna.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a handheld computing device;

FIG. 2 is a block diagram of one embodiment of a computer system;

FIG. 3 is a block diagram of one embodiment of a network controller; and

FIG. 4 illustrates another embodiment of a handheld computing device.

### DETAILED DESCRIPTION

An antenna embedded within a display is described. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

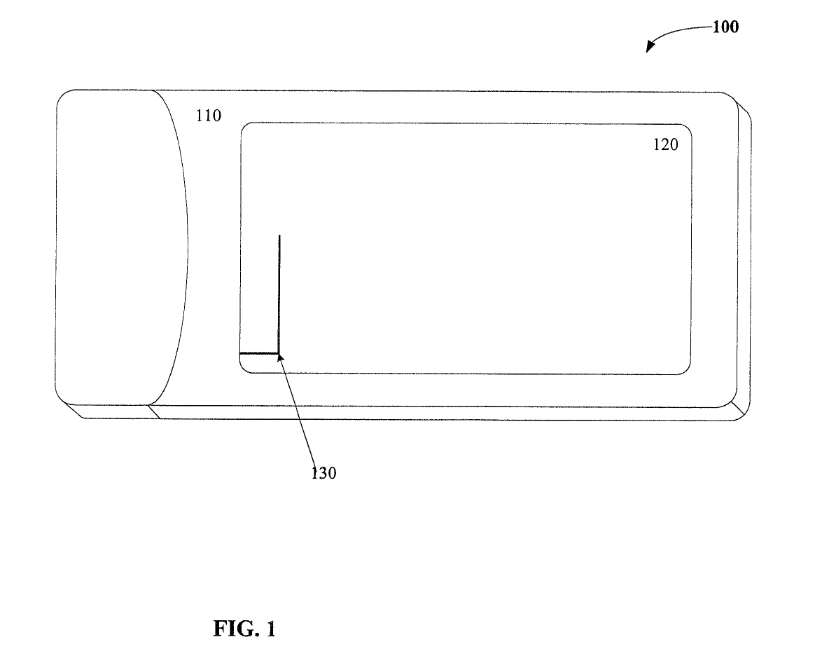

FIG. 1 illustrates a frontal view of one embodiment of a handheld computing device 100. According to one embodiment, handheld device 100 is a personal computing (PC) tablet. A PC tablet is a portable computing device that enables a user to input data by touching the display with a finger or stylus. In another embodiment, device 100 is a personal digital assistant (PDA). In other embodiments, handheld device 100 may be a two-way pager or an integrated electronic mail (e-mail) device.

Computing device 100 includes housing 110, display 120 and antenna 130. Housing 110 encloses one or more printed circuit boards (PCBs). The PCBs include various electronic components mounted thereon that provide computing functionality for device 100. In one embodiment, housing 110 is an elongated structure that fits into the hands of a device 100 user. Display 120 is mounted within housing 110.

Display 120 is a projecting mechanism that shows text and graphic images to a device 100 user. In one embodiment, display 120 is a touch screen display that facilitates data entry by touching display 120 with a stylus. In a further embodiment, display 120 is implemented with a liquid crystal display (LCD). In yet another embodiment, the LCD is a reflective-transmissive LCD (e.g., 30% transmissive and 70% reflective). However, one of ordinary skill in the art will appreciate that display 120 may be implemented using other image projection technology.

Antenna 130 is located on display 120. In one embodiment, antenna 130 is an end-fed dipole antenna that converts RF fields into alternating current (AC), and vice-versa. According to one embodiment, antenna 130 is etched onto display 120. Thus, during the manufacture of device 100, a chemical material is etched (wet or dry) into display 120 to form antenna 130.

In another embodiment, antenna 130 may be sputter etched onto display 120 by bombarding display 120 with high energy ions extracted from a ferro-magnetic plasma. In yet another embodiment, antenna 130 may be embedded on the under side of display 120. According to a further embodiment, antenna 130 is coupled to an amplification circuit that is also mounted on display 120.

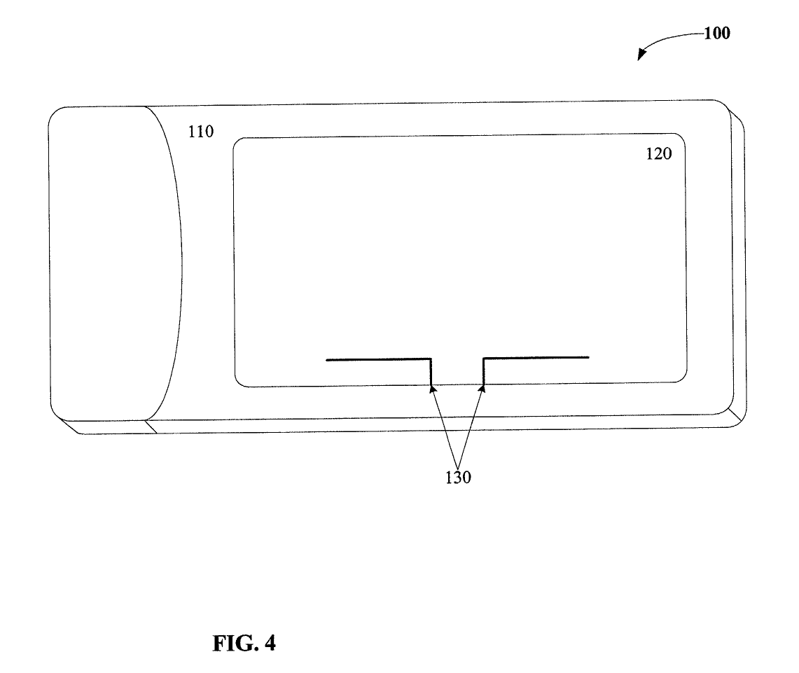

FIG. 4 illustrates another embodiment of handheld device 100. In this embodiment, antenna 130 is implemented using a center-fed dipole. The center-fed dipole includes two components, each having a ¼ wavelength. Thus, the center-fed dipole has a full ½ wavelength.

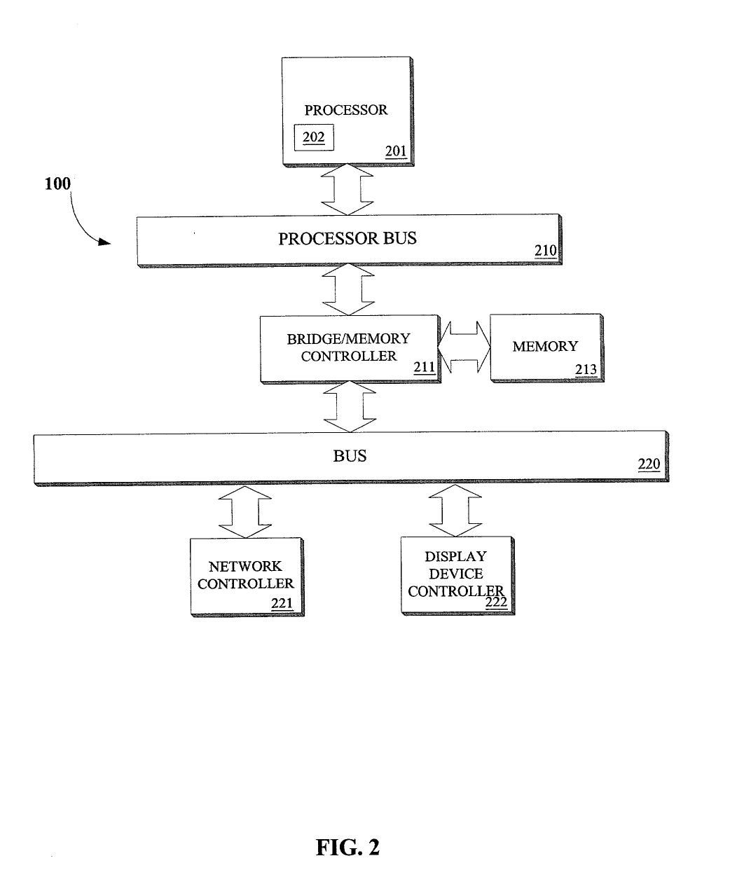

FIG. 2 is a block diagram of one embodiment of the computing components within handheld device 100. Device 100 includes a processor 201 that processes data signals. Processor 201 may be a complex instruction set computer (CISC) microprocessor, a reduced instruction set computing (RISC) microprocessor, a very long instruction word (VLIW) microprocessor, a processor implementing a combination of instruction sets, or other processor device.

In one embodiment, processor 201 is a processor in the Pentium® family of processors including the Pentium® 4 family and mobile Pentium® and Pentium® 4 processors available from Intel Corporation of Santa Clara, Calif. Alternatively, other processors may be used. FIG. 2 shows an example of a device 100 employing a single processor computer. However, one of ordinary skill in the art will appreciate that device 100 may be implemented using multiple processors.

Processor 201 is coupled to a processor bus 210. Processor bus 210 transmits data signals between processor 201 and other components in device 100. Device 100 also includes a memory 213. In one embodiment, memory 213 is a dynamic random access memory (DRAM) device. However, in other embodiments, memory 213 may be a static random access memory (SRAM) device, or other memory device.

Memory 213 may store instructions and code represented by data signals that may be executed by processor 201. According to one embodiment, a cache memory 202 resides within processor 201 and stores data signals that are also stored in memory 213. Cache 202 speeds up memory accesses by processor 201 by taking advantage of its locality of access. In another embodiment, cache 202 resides external to processor 201.

Device 100 further comprises a bridge memory controller 211 coupled to processor bus 210 and memory 213. Bridge/memory controller 211 directs data signals between processor 201, memory 213, and other components in device 100 and bridges the data signals between processor bus 210, memory 213, and a first input/output (I/O) bus 220. In one embodiment, I/O bus 220 may be a single bus or a combination of multiple buses.

In a further embodiment, I/O bus 220 may be a Peripheral Component Interconnect adhering to a Specification Revision 2.1 bus developed by the PCI Special Interest Group of Portland, Oreg. In another embodiment, I/O bus 220 may be a Personal Computer Memory Card International Association (PCMCIA) bus developed by the PCMCIA of San Jose, Calif. Alternatively, other busses may be used to implement I/O bus. I/O bus 220 provides communication links between components in device 100.

A display device controller 222 is also coupled to I/O bus 220. Display device controller 222 controls display 120, and acts as an interface between display 120 and other device 100 components. Display 120 receives data signals from processor 201 through display device controller 222 and displays the information and data signals to the user of device 100.

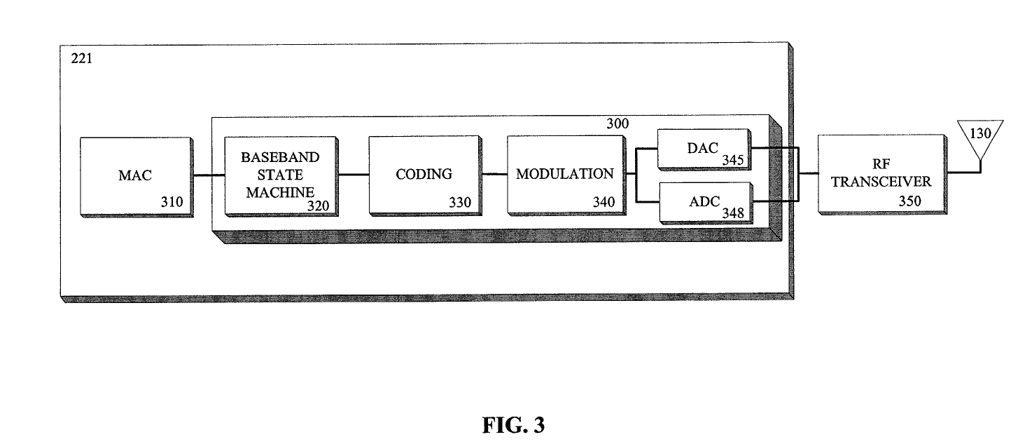

A network controller 221 is coupled to I/O bus 220. Network controller 221 links device 100 to a network of computers (not shown in FIG. 2) and wireless devices. Moreover, network controller 221 supports communication among the machines. According to one embodiment, network controller 221 enables device 100 to implement a wireless radio application via one or more wireless network protocols. FIG. 3 is a block diagram of one embodiment of network controller 221.

Referring to FIG. 3, network controller 221 includes a baseband 300, a media access control layer (MAC) 310, a digital to analog converter (DAC) 345, and an analog to digital converter (ADC) 348. In one embodiment, DSP 300 is an embedded DSP. According to one embodiment, baseband 300, MAC 310, and DAC 345 and ADC 348 are controlled by separate embedded digital signal processors (DSPs).

An embedded DSP typically integrates a processor core, a program memory device, and application-specific circuitry on a single integrated circuit die. One of ordinary skill in the art will appreciate that one or more of the DSPs may be replaced with other components (e.g., field programmable gate arrays (FPGAs) without departing from the scope of the invention).

MAC 310 controls the means by which multiple devices share the same media channel of transmission medium 130. According to one embodiment, MAC 310 processes data to be transmitted to another computer system via transmission medium 130. In particular, MAC 310 retrieves data from memory 213 that is to be transmitted from device 100.

Similarly, MAC 310 receives and processes data packets received at network controller 221. Moreover, MAC 310 controls the timing of transmitted and received data packets at network controller 221. Baseband 300 includes baseband state machine 320, coding 330, and modulation 340. Baseband state machine 320 is coupled to MAC 310 and prepares data received from MAC 310 for transmission. According to one embodiment, baseband state machine 320 performs pseudo-noise code spreading. Moreover, baseband state machine 320 also provides scrambling for interference rejection and antenna diversity for better coverage.

Coding 330 encodes data received from baseband state machine 320 and decodes data received from modulation 340. Coding 330 is used to improve the performance of the wireless radio application of network controller 221. According to one embodiment, coding 330 implements a convolutional code. Convolutional code is a type of error-correction code in which (a) each m-bit information symbol (e.g., each m-bit string) to be encoded is transformed into an n-bit symbol, where n>m and (b) the transformation is a function of the last k information symbols, where k is the constraint length of the code.

Modulation 340 modulates the baseband data to place the data in an intermediate frequency range. Modulation 340 also demodulates data received at network controller 221. DAC 345 is coupled to modulation 345. DAC 345 converts the modulated baseband signal from digital to analog for transmission. ADC 348 converts received analog signals to a digital format prior to de-modulation at modulation 340.

Network controller 221 is coupled to a radio frequency (RF) transceiver 350. Transceiver 350 is coupled to DAC 345 and ADC 348. Transceiver 350 receives and transmits data from network controller 221 on air. Transceiver 350 includes a power amplifier that amplifies the modulated data packets prior to transmission. Further, transceiver 350 operates in a complementary manner when receiving a packet. In one embodiment, transceiver 350 is mounted on display 120 using chip on glass technology.

Antenna 130 is coupled to transceiver 350. As described above, antenna 130 is located on display 120. Antenna 130 supplies the received packet to transceiver 350. The packet is then demodulated and decoded to obtain a baseband packet, which it supplied to baseband 320. After processing this packet, baseband 320 notifies MAC 310 that it has received packet data.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. A handheld computing device comprising:
a housing;
a display mounted on the housing; and
an antenna located on the display.

2. The device of claim 1 wherein the antenna is etched on the display.

3. The device of claim 1 wherein the antenna is sputter etched on the display.

4. The device of claim 1 wherein the antenna is embedded under the display.

5. The device of claim 1 further comprising an amplification circuit coupled to the antenna.

6. The device of claim 5 wherein the amplification circuit is mounted on the display.

7. The device of claim 6 wherein the amplification circuit is mounted on the display using chip on glass technology.

8. The device of claim 1 wherein the antenna is a center-fed dipole antenna.

9. The device of claim 1 wherein the antenna is an end-fed dipole antenna.

10. The device of claim 1 where in the handheld computing device is a personal computer (PC) tablet.

11. The device of claim 1 wherein the handheld computing device is a personal digital assistant (PDA).

12. A method comprising, mounting an antenna on a display of a computing apparatus.

13. The method of claim 12 wherein mounting the antenna further comprises etching the antenna on the display.

14. The method of claim 12 wherein mounting the antenna further comprises sputter etching the antenna on the on the display.

15. The method of claim 12 wherein mounting the antenna further comprises embedding under the display.

16. The method of claim 1 further comprising coupling an amplification circuit to the antenna.

17. The method of claim 16 wherein coupling the amplification circuit to the antenna further comprises mounting the amplification circuit on the display.

18. The method of claim 17 wherein the amplification circuit is mounted on the display using chip on glass technology.

19. The method of claim 12 wherein the computing apparatus is a personal computer (PC) tablet.

20. The method of claim 12 wherein the computing apparatus is a personal digital assistant (PDA).

21. A handheld computing device comprising:
a display;
a radio frequency (RF) transceiver mounted on the display; and
an antenna, coupled to the RF transceiver, mounted on the display.

22. The device of claim 21 further comprising a network controller coupled to the RF transceiver.

23. The device of claim 22 wherein the network controller further comprises:
media access layer (MAC) digital signal processor (DSP); and
a baseband DSP coupled to the MAC DSP.

24. The device of claim 23 wherein the baseband DSP comprises:
a baseband state machine;
a coding element coupled to the baseband state machine; and
a modulation element coupled to the coding.

25. The device of claim 24 wherein the baseband DSP further comprises:
a digital to analog converter (DAC) DSP coupled to the baseband DSP; and
an analog to digital converter (ADC) DSP coupled to the baseband DSP.

26. The device of claim 21 wherein the handheld computing device is a personal computer (PC) tablet.

27. The device of claim 21 wherein the handheld computing device is a personal digital assistant (PDA).
